(19) United States
(12) Patent Application Publication
(10) Pub. No.: US 2011/0056768 A1
(43) Pub. Date: Mar. 10, 2011

(54) Clydesdale saw horse

(76) Inventor: Dennis G. Budreau, Sedona, AZ (US)

(21) Appl. No.: 12/806,961

(22) Filed: Aug. 25, 2010

Related U.S. Application Data
(60) Provisional application No. 61/275,105, filed on Aug. 25, 2009.

(51) Int. Cl. B25H 1/06

(52) U.S. Cl. 182/129; 182/186.4

(57) ABSTRACT

The present invention provides a metal, height-adjustable, folding sawhorse, easily assembled in moments, strong enough for heavy loads, and, when no longer needed, easily collapsed into a compact, flat package for storage or transport. Manufactured by the Fabricated Metal Products industry, the Clydesdale Saw Horse is fabricated of a lightweight steel allow or a fairly heavy gauge aluminum alloy.

### CLAIM OF PRIORITY

This patent application claims priority under 35 USC 119(e)(1) from U.S. Provisional Patent Application Ser. No. 61/275,105 filed Aug. 25, 2009, of common inventorship herewith entitled, “Clydesdale Saw Horse.”

### FIELD OF THE INVENTION

The present invention pertains to the field of construction equipment, and more specifically to the field of saw horses, and even more specifically to the field of collapsible saw horses.

### BACKGROUND OF THE INVENTION

The prior art has put forth several designs for collapsible saw horses. Among these are:

U.S. Pat. No. 4,926,966 to Alban M. Boudreau describes a folding saw horse comprised of a back and two leg pairs, wherein the leg pairs are held in brackets that fix the legs in an inverted V and swing at the apexes of the V.

U.S. Pat. No. 7,172,053 to Stefano Slavich describes a knockdown saw horse comprising first and second beam sections which are pivotally connected to form a storage housing and leg assemblies pivotally connected thereto.

U.S. Pat. No. 7,185,738 to Jerry Clepper describes a modular saw horse comprising hinged sections to collapse, stack and mount for storage and transport.

None of these prior art references describe the present invention.

### BRIEF DESCRIPTION OF THE DRAWINGS

FIG. 1 is a top perspective view of the saw horse of the present invention in the upright position.

FIG. 2 is a close up of the legs of the saw horse of the present invention.

FIG. 3 is a top perspective view of the saw horse of the present invention in the collapsed position.

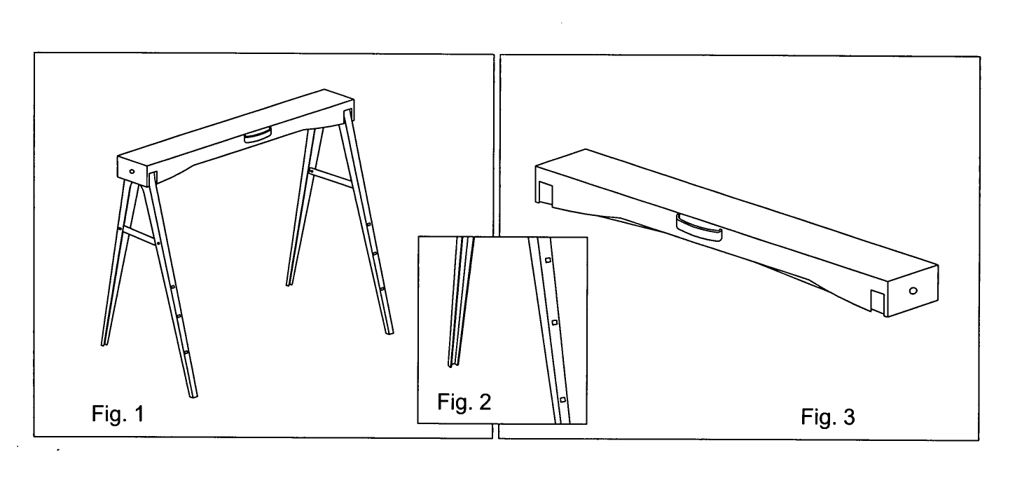

### DETAILED DESCRIPTION OF THE INVENTION

For many projects, the first item of business for the carpenter is building a pair of sawhorses. A pair of sawhorses is indispensable for everything from cutting plywood and framing members to use as a table for laying out plans and sketches, and building a pair of saw horses is a precise, time-consuming job.

A sawhorse is a simple apparatus comprising a horizontal top rail supported by two A-frame, cross-braced legs. A pair of sawhorses is stable and sturdy. The trouble with wooden sawhorses is that they are heavy and bulky, don't stack very well, and generally, at the conclusion of the job, get left behind by the work crew.

Recognizing the time, cost, and waste involved in the on-site building of wooden sawhorses, the present invention, hereinafter referred to as the Clydesdale Saw Horse, was developed.

Simply stated, the Clydesdale Saw Horse is a metal, height-adjustable, folding sawhorse, easily assembled in moments, strong enough for heavy loads, and, when no longer needed, easily collapsed into a compact, flat package for storage or transport. Manufactured by the Fabricated Metal Products industry, the Clydesdale Saw Horse is fabricated of a lightweight steel allow or a fairly heavy gauge aluminum alloy, and is manufactured and sold as a pair.

When assembled for use, the Clydesdale Saw Horse resembles, in overall appearance, a standard sawhorse, with a flat horizontal top rail and a set of A-frame legs at each end, each pair of legs connected by a hinged, locking metal cross-brace. The top rail, which measures about 38 inches in length by about 4 inches in width, flares outward slightly at each end, with corner-set notches to receive and lock in the tops of the four legs. The legs themselves are cut from lengths of half-squared metal tubing, such that the flat side is presented outwardly, and the concave or squared surface is presented to the interior. The legs are fitted with precut slots, set at intervals along their length. The height of the legs is adjustable in the following manner: fitted to the inside of each leg is a sliding, inset length of half-squared metal tubing, identical to the outer leg but of slightly smaller diameter. These inset lengths can thus be moved up or down, within the outer leg. The inset lengths are also fitted with precut slots. The slot in the moveable inset piece will align with a given slot in the outer leg, and can be locked into that position with a carriage bolt and wing nut. Thus, the effective leg-length, and therefore the height, of the Clydesdale Saw Horse varies from about 25 to 34 inches, depending on the positioning of the sliding inset leg extenders. The legs themselves, when spread for use, are locked into the spread position by tightening a bolt which connects them to the top rail of the horse. This bolt runs through the top of both legs, and therefore forms a pivot point which, when the bolt is loosened, allows the legs to be folded in together. When spread, as noted, the legs are connected by a hinged, locking, strap-type brace. This cross-brace can also be locked when the legs are fully extended and spread, thus ensuring full stability of the horse. The Clydesdale Saw Horse is a metal sawhorse the height of which is adjustable, with legs that lock in the spread position and fold together when unlocked. The collapsible nature of the saw horse of the present invention is that the legs not only fold together, they also swing inward, along the plane of the top horizontal rail. When the unit is collapsed, it literally folds down into a virtually flat package, the length (38 inches) and width (4 inches) of the top horizontal rail itself. In an alternative embodiment, a set of suitcase-type carrying handles, which are set on the side of the top horizontal rail of each horse are included.

The Clydesdale Saw Horse, a height-adjustable metal sawhorse that folds flat for storage and transport, presents a number of distinct benefits and advantages. Foremost, the Clydesdale Saw Horse saves carpenters the necessity of building a set of wooden sawhorses at the site of each new job. With the Clydesdale Saw Horse, a worker simply removes the stowed horses from the truck, pulls the legs down and out, adjusts the leg-height, tightens the nuts which lock the horse into working order, and sets to work. Likewise, when the day's work is finished, a couple of turns to loosen the locking nuts, and the Clydesdale Saw Horse folds up as easily as a card-table. And then, because it folds up into such a compact unit, the pair of Clydesdale Saw Horses can easily be carried and stowed away in the work truck. Lightweight and manufactured of high-strength alloys, the Clydesdale Saw Horse provides heavy-duty, dependable service on a multiplicity of jobs. In an embodiment, the metal is sealed with a rustproof paint or powder coating, rendering the Clydesdale Saw Horse impervious to moisture and weather. In the way of maintenance, all that the Clydesdale Saw Horse requires is an occasional wipe-down with a damp cloth, and the occasional drop of oil on the moving parts.

A sturdy, height-adjustable metal saw horse that collapses into a virtually flat package for transport and storage, the Clydesdale Saw Horse provides a stable base for carpentry and other tasks, yet proves far more convenient to carry and store than other, conventional saw horses. Built of heavy-duty materials and designed for the long haul, the Clydesdale Saw Horse is surprisingly affordable, and would pay for itself in the time and materials savings it made possible.

Although this invention has been described with respect to specific embodiments, it is not intended to be limited thereto and various modifications which will become apparent to the person of ordinary skill in the art are interested to fall within the spirit and scope of the invention as described herein taken in conjunction with the accompanying drawings and the appended claims.

What is claimed:

1. A method of file management in an electronic processing system comprising:
defining in the electronic system an electronic file of a selected file type and at least one electronic sub-folder within the electronic file for storing information of a corresponding information type, including:
receiving file record information from an administrator to set up the electronic file and the at least one electronic sub-folder;
comparing in the electronic system at least some of the received file record information with information previously stored in the electronic system;
when a match occurs between the at least some of the received file record information and the information previously stored, reporting conflicting file records to the administrator; and
allowing the administrator to selectively combine conflicting file records to create a single file record, selectively purge a conflicting file record, selectively make a first conflicting file record a parent and a second conflicting file record a child file record, and selectively associate conflicting file records with different files;
defining roles in the electronic processing system for participants creating and utilizing the electronic file, including a role for at least one participant as an information collector, including defining a role for a reviewer;
electronically tasking the information collector to collect information of the information type;
selectively uploading the selected information from the information collector and selectively storing the uploaded information in the sub-folder in the electronic file, including:
electronically tasking the reviewer to review and selectively accept the uploaded information prior to storage in the sub-folder;
receiving an electronic rejection of the uploaded information from the reviewer; and
electronically tasking a selected participant to recollect the selected information; and
allowing selected ones of the participants to access the electronic file as defined by the corresponding roles.

2. (canceled)

3. The method of claim 1, wherein defining roles comprises defining a role for a file user and the method further comprises electronically tasking the file user to review and selectively accept the uploaded information prior to storage in the sub-folder.

4. The method of claim 1, wherein electronically tasking the information collector and selectively uploading the selected information comprise:
sending an electronic assignment to the information collector to collect the selected information;
receiving an electronic assignment acceptance from the information collector in response to the electronic assignment; and
uploading the selected information from the information collector.

5.-8. (canceled)

9. The method of claim 1, wherein defining roles in the electronic processing system for participants is performed by a system administrator and further comprises:
defining access levels corresponding to the roles in response to administration input;
selecting the participants in response to administration input;
mapping in the electronic system the selected participants to the roles.

10. The method of claim 9, wherein the defined roles are selected from the group consisting of file users, reviewers, and information collectors.

11. (canceled)

12. A method of file management in an electronic processing system comprising:
defining in the electronic system an electronic file of a selected file type and at least one electronic sub-folder within the electronic file for storing information of a corresponding information type, including:
setting up the electronic file by selectively inputting file record information into the electronic system and allowing an administrator to selectively create the electronic file within the electronic system based on the contents of the file record information;
comparing with the electronic system the input file record information with existing file record information stored within the electronic system; and
when a match occurs between the input file record information and the existing file record information, selectively allowing the administrator to reconcile the input file record information and the existing file record information, including allowing the administrator to selectively combine conflicting file records to create a single file record, selectively purge a conflicting file record, selectively make a first conflicting file record a parent and a second conflicting file record a child file record, and selectively associate conflicting file records with different files;
defining roles in the electronic processing system for participants creating and utilizing the electronic file, including a role for at least one participant as an information collector;
electronically tasking the information collector to collect information of the information type;
selectively uploading the selected information from the information collector and selectively storing the uploaded information in the sub-folder in the electronic file; and
allowing selected ones of the participants to access the electronic file as defined by the corresponding roles.

13. An electronic file management system comprising:
a plurality of terminals for interfacing with a plurality of participants utilizing the file management system;
a processing system communicating with the terminals for storing and managing electronic files, wherein each file is categorized by a selected file type and includes at least one electronic sub-folder for storing information of a corresponding information type, the processing system operable to:
allow an administrator to define an electronic file of the selected file type including:
receive file record information from the administrator to set up the electronic file and the at least one electronic sub-folder;
compare in the electronic system at least some of the received file record information with information previously stored in the electronic system,
when a match occurs between the at least some of the received file record information and the information previously stored, reporting conflicting file records to the administrator; and
allow the administrator to selectively combine conflicting file records to create a single file record, selectively purge a conflicting file record, selectively make a first conflicting file record a parent and a second conflicting file record a child file record, and selectively associate conflicting file records with different files:
in response to input from the administrator, set-up roles for the participants including a role for at least one information collector;
in response to input from the administrator, electronically task the information collector to collect information of a select information type for a selected electronic file;
selectively upload of the selected information from the information collector;
selectively store the uploaded information in a sub-folder corresponding to the selected information type in the selected electronic file;
control access by selected ones of the participants to the selected electronic file as defined by the corresponding roles;
receive an electronic rejection of the uploaded information from a reviewer,
electronically notify the administrator of the rejection of the uploaded information; and
in response to input from the administrator, electronically task a selected participant to recollect the selected information.

14. The electronic file management system of claim 13, wherein the processing system tasks the information collector by entering task on an electronic to-do list accessible through the terminal associated with the information collector.

15. The electronic file management system of claim 13, wherein the processing system sets-up a role for a reviewer in response to input from the administrator and is further operable to:
in response to input from the administrator, electronically task the reviewer to review the uploaded information;
allow the reviewer to selectively access the electronic file through a corresponding one of the terminals; and
allow the reviewer to selectively accept the uploaded information prior to storage in the sub-folder of the selected electronic file.

16. The electronic file management system of claim 15, wherein the processing system tasks the reviewer by entering an entry on an electronic to-do list accessible through the terminal associated with the reviewer.

17. The electronic file management system of claim 13, wherein the processing system sets-up role for a file user in response input from the administrator and is further operable to:
in response to input from the administrator, electronically task the file user to review the uploaded information;
allow the file user to selectively access the electronic file through a corresponding one of the terminals; and
allow the file user to selectively accept the uploaded information prior to storage in the sub-folder of the electronic file.

18. (canceled)

19. An electronic file management system comprising:
a plurality of terminals for interfacing with a plurality of participants utilizing the file management system;
a processing system communicating with the terminals for storing and managing electronic files, wherein each file is categorized by a selected file type and includes at least one electronic sub-folder for storing information of a corresponding information type, the processing system operable to:
in response to input from an administrator, set-up roles for the participants including a role for at least one information collector,
in response to input from the administrator, electronically task the information collector to collect information of a select information type for a selected electronic file;
selectively input file record information;
allow the administrator to selectively create the electronic file within the electronic system based on the contents of the file record information;
compare the input file record information with existing file record information stored within the electronic system; and
when a match occurs between the input file record information and the existing file record information, selectively allow the administrator to reconcile the input file record information and the existing file record information by selectively combining conflicting file records to create a single file record, selectively purging a conflicting file record, selectively making a first conflicting file record a parent and a second conflicting file record a child file record, and selectively associating conflicting file records with different files;
selectively upload of the selected information from the information collector;
selectively store the uploaded information in a sub-folder corresponding to the selected information type in the selected electronic file; and
control access by selected ones of the participants to the selected electronic file as defined by the corresponding roles.

20. The electronic file management system of claim 19, wherein the processing system inputs file record information from an electronic information warehouse.
